(19) United States
(12) Patent Application Publication
(10) Pub. No.: US 2005/0242132 A1
(43) Pub. Date: Nov. 3, 2005

(54) Plastic single-piece tube

(76) Inventor: Emilio Morini, Parma (IT)

Correspondence Address: YOUNG & THOMPSON, 745 SOUTH 23RD STREET, 2ND FLOOR, ARLINGTON, VA, 22202, US

(21) Appl. No.: 10/519,497

(22) PCT Filed: Jul. 2, 2002
(86) PCT No.: PCT/IT02/00437

§ 371 Date: Dec. 30, 2004

(51) Int. Cl. B67D 3/00; B65D 47/00

(52) U.S. Cl. 222/556

(57) ABSTRACT

The tube, in particular for containing fluid products such as creams and cosmetic products in general, includes: a trunco-conical body (1a) having a lower part (1b) which is open for introduction of the product, and can be closed after the introduction; and also an upper part (1c) affording a passage for exit of the product from the tube. A cap (3) can be applied on the upper part (1c) of the tube for closing the passage and is connected to the upper part (1c) of the tube by a hinge element (4). The tube, the cap (3) and the hinge element (4) are all made in a single piece obtained by injection moulding.

### TECHNICAL FIELD

The invention relates to a single-piece tube made of plastic. For some time plastic tubes have been used in substitution for metal tubes, especially in the technical field of tubes destined to contain fluid products such as creams or in general cosmetic products.

### BACKGROUND ART

The tubes in this field usually include a central body having a lower part which is open for the introduction of the product, and which is closed after the filling operation. The upper part of the central body has a passage for the exit of the product from the tube. These tubes are made by either welding the upperpart to a drawn cylindrical tube, or by directly moulding the whole tube by injection of plastic material in a special die. The present invention relates in particular to the latter type of tube.

The finished tube is sent to producers of the product destined to fill the tube by introduction into the open lower part, whereupon the bottom of the tube is welded, the top of the tube is closed by a cap, usually screwed on by means of a thread located at the opening, which the user will then unscrew to access the product, and rescrew to seal the tube until next use.

Document DE 44 12 907 C1 discloses a plastic tube, comprising a cylindrical body having an upper part provided with a passage for exit of the product. The tube comprises a cap which can be applied on the upper part of the tube for closing the passage, which cap is connected to the upper part of the tube by a hinge element. The upper part of the tube, the cap and the hinge element are made in a single piece.

As with all objects whose unit cost is relatively low but which are produced in large numbers, the main problem the producers face is how to limit costs and production times, by limiting the number of separate parts needed to make the object and by reducing to a minimum production waste. A further problem faced is how to reduce space and despatch and storage costs.

A further problem is how to facilitate both intermediate and final use.

The main aim of the present invention is to make a single-piece tube of a plastic material which contributes much to reducing production and storage costs, and which facilitates the use of the final product.

An advantage of the invention is to provide a tube whose external surface has a good finish, obtained during the moulding operation.

A further advantage of the invention is that it provides a tube having high mechanical resistance.

These aims and advantages and others besides are all achieved by the present invention, as it is characterised in the appended claims.

### DISCLOSURE OF INVENTION

Further characteristics and advantages of the present invention will better emerge from the detailed description that follows, of some preferred but not exclusive embodiments thereof, illustrated purely by way of example in the accompanying figures of the drawings, in which:

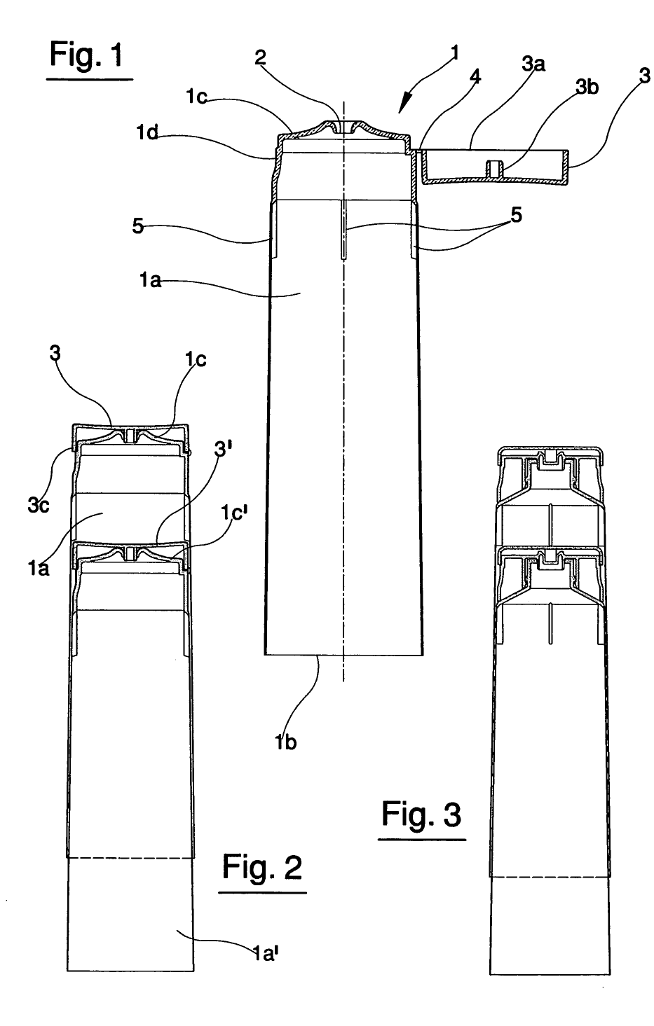

FIG. 1 is a section in vertical elevation of a first embodiment of the tube of the invention;

FIG. 2 is a reduced-scale view of a section of two tubes as in FIG. 1, one inserted in another;

FIG. 3 shows a section of two tubes, slightly differently made with respect to those illustrated in FIGS. 1 and 2, one inserted in another.

In FIGS. 1 and 2, 1 denotes a single-piece tube made of plastic. The plastic material used can be of known type and is suitable for injection-moulding.

The tube comprises a trunco-conical body 1a which exhibits a coning angle of between 1° and 4° and which has an open lower part 1b. In filling plants this open lower part 1b is used to fill the tube. The lower part 1b of the tube can be closed after the introduction of the fluid product, for example by hot-welding.

The tube is further provided with an upper part 1c, which in this embodiment is an integral part of the tube, in which a passage is provided for exit of the product from the tube during use of the product by the final user. The passage 1c comprises a cylindrical hole 2 which opens conically towards the outside and which is arranged coaxially to the tube 1.

The tube 1 further comprises a cap 3 conformed so as to cover the upper part 1c of the tube and close the cylindrical hole 2. The cap 3 comprises a cylindrical projection 3b fashioned on the internal bottom of the cap 3, which inserts sealingly in the cylindrical hole 2 when the cap 3 is placed on the upper part 1c of the tube.

The cap 3 is connected to the upper part 1c of the tube by a hinge element 4 which comprises a flat band 4 which connects an intermediate zone of the upper part 1c of the tube to a free edge 3a of the cap 3. The upper part 1c of the tube and the cap 3 are conformed in such a way that the cap 3, when placed on the upper part 1c of the tube to close the hole 2, is in fact a continuation of the trunco-conical body of the tube 1.

To facilitate removal of the cap 3 from the upper part of the tube, i.e. to open the tube 1, a slight recess 1 is afforded on the lateral wall of the upper part 1c of the tube 1, which recess reveals a short tract 3c of cap 3 below which a user's finger can insert, press and remove the cap 3. The recess 1d is afforded in a diametrically-opposite position to the hinge element 4.

The tube 1, the cap 3 and the hinge element 4 are all made in a single piece during the injection-moulding of the tube 1. In particular, the tube 1 is obtained using the known process of multiple injections of material internally of a mould. In this way the hinge element 4 is made together with the cap 3 by injection of plastic material of a different colour to that used for the remaining part of the tube 1.

The upper part 1c of the tube 1 and the cap 3 are slightly thicker than the trunco-conical body of the tube 1. In a brief tract of tube 1 between the upper part of the tube and the remaining part of the tube 1, there are thin internal ribs 5 which are arranged in a radial direction. In particular, in the illustrated tube, four ribs are present and located equidistant from each other. This particular conformation of the upper part 1c of the tube 1 enables a greater consistency to be obtained for that part of the tube, and facilitates the exit of the product from the tube 1. This greater consistency does not however constitute an obstacle to the squeezing of the tube 1 to cause the product to exit, which in fact does happen with some known tubes, such as for example those tubes made using the technique of welding the upper part of the tube to an extruded tube body. In this kind of realisation, the welding zone becomes a little stiffer, which makes the tube difficult to squeeze. The internal ribs 5 also have a further important function in relation to the stocking of the tubes, as will be better explained herein below.

The tube of the invention, which is made together with the cap in a single moulding process, confers high productivity on the moulds. Its shape also makes the tubes easy to stack, as shown in FIG. 2, in piles which can include a large number of tubes, all in one piece with their caps 3. This makes for very considerable savings in transport costs for the empty tubes to the users. In particular, the tubes can be inserted one in another but will not stick to each other, thanks to the presence of the ribs 5 which stop axial-direction penetration of one tube in another and render their uncoupling very easy. This function could obviously be performed by ribs or stops of different shape and location to the ones illustrated.

The tube can be made using parts of different colours. Also, as there are no glued or superposed parts, the tube exhibits considerable mechanical resistance. The tube described further exhibits a surface finishing, both internal and external, which is of very high quality, obtained directly during the moulding stage without any further operations being necessary, as in other known tubes. This gives greater slidability of the product inside the tube, and eliminates or at least renders easier any external surface finishing operations.

Finally, the presence of the cap made directly during the tube-manufacturing process, and therefore solidly connected to the tube, not only facilitates production, storage and transport, but also makes the tube easier to use for the final user.

The above-described solution is preferable inasmuch as it provides a greater number of advantages with respect to the prior art. It is, however, possible to realise the upper part of the tube (which in this version is not destined to contain product and strictly speaking is not even a part of the tube) the cap and the hinge element as a separate part which is then connected to the tube, for example by means of a known-type connection of a screw- or joint-type, between the upper part and the tube itself This solution, illustrated in FIG. 3, would not offer the advantages connected with a single moulding process producing the tube together with the hinge and cap, but would still have the advantages of being easy to transport and storage, and it would still be mechanically resistant and have good finishing.

1-10. (canceled)

11. A plastic single-piece tube, comprising a trunco-conical body (1a) having a lower part (1b) which is open for introduction of a product and closeable after the introduction, and an upper part (1c) provided with a passage for exit of the product; wherein the tube comprises a cap (3) which can be applied on the upper part (1c) of the tube for closing the passage, which cap (3) is connected to the upper part (1c) of the tube by a hinge element (4); at least the upper part (1c) of the tube, the cap (3) and the hinge element (4) being made in a single piece obtained by injection moulding;
the upper part (1c) and the cap (3) being conformed in such a way that the cap (3) applied on the upper part (1c) is a continuation of the trunco-conical body (1a) of the tube; the upper part (1c) of the tube and the cap (3) being slightly thicker than the trunco-conical body (1a) of the tube; wherein the passage afforded on the upper part (1c) of the tube comprises a cylindrical hole (2) which opens conically towards an outside and is arranged coaxially to the tube (1); the cap (3) comprising a cylindrical projection (3b), fashioned on an internal bottom of the cap (3), which is conformed and arranged in such a way as to insert sealingly in the cylindrical hole (2) when the cap (3) is applied on the upper part (1c) of the tube;
characterized in that in a brief tract of the tube situated between the upper part (1c) and the remaining part of the tube internal thin ribs (5) are fashioned.

12. The tube of claim 11, wherein the whole tube, together with the cap (3), is made in a single piece by multiple injections of plastic material into a mould.

13. The tube of claim 12, wherein the hinge element (4) and the cap (3) are made by injection of plastic material of different colours with respect to a colour used for a remaining part of the tube.

14. The tube of claim 11, wherein the hinge element (4) comprises a flat band (4) which connects an intermediate zone to the upper part (1c) of the tube to a free edge (3a) of the cap (3).

15. The tube of claim 11, wherein a coning angle of the trunco-conical body is comprised between 1° and 4°.

16. The tube of claim 12, wherein on a lateral wall of the upper part (1c) of the tube a recess (1d) is afforded, made at a diametrically-opposite position to the hinge element (4) which, when the cap (3) is applied on the upper part (1c) of the tube, reveals a brief tract (3c) of cap (3).
